(19) United States
(12) Patent Application Publication
(10) Pub. No.: US 2015/0088610 A1
(43) Pub. Date: Mar. 26, 2015

(54) Equipping a Sales Force to Identify Customers

(71) Applicants: Christopher R. Bayles, Union, NJ (US); Glenn Connery, Warminster, PA (US); Steven L. DeWitt, Philadelphia, PA (US)

(72) Inventors: Christopher R. Bayles, Union, NJ (US); Glenn Connery, Warminster, PA (US); Steven L. DeWitt, Philadelphia, PA (US)

(73) Assignee: IMS HEALTH INCORPORATED, Danbury, CT (US)

(21) Appl. No.: 14/034,911

(22) Filed: Sep. 24, 2013

(51) Int. Cl. G06Q 30/02

(52) U.S. Cl. CPC G06Q 30/0205
USPC 705/7.34

(57) ABSTRACT

The disclosure generally describes computer-implemented methods, software, and systems for identifying a preferred next best customer for pharmaceutical sales representatives to contact to promote a pharmaceutical product. A customer can be defined as any health care practitioner, health care facility, health care hospital system, or health care plan.

### BACKGROUND

Pharmaceutical sales representatives spend a lot of time on the road talking with health care practitioners and pharmacists promoting pharmaceutical products. Managing scheduling with customers is important.

### OVERVIEW

The present disclosure relates to computer-implemented methods, software, and systems for identifying a preferred “next best customer” for pharmaceutical sales representatives to contact to promote a pharmaceutical product. The disclosure relates to implementations that facilitate the accessing of customer dynamics data and location information of customers and the processing this information by an analytical infrastructure to identify a next best customer. A customer can be defined as any health care practitioner, health care facility, health care hospital system, or health care plan.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example of an analytical infrastructure system implemented in a computing system 100.

FIGS. 2-7 illustrate example user interfaces of user interaction with a webpage application of a schedule management tool.

FIG. 8 is a flow chart of a process by which an analytical infrastructure uses customer dynamics data and geographical location data to generate one or more customers to contact based on customer score.

FIG. 9 illustrates a table with the attributes and measures used for calculating customer score.

### DETAILED DESCRIPTION

This disclosure generally describes computer-implemented methods, software, and systems for identifying preferred “next best customer” for pharmaceutical sales representatives to contact a customer in order to promote a pharmaceutical product. The disclosure describes implementations that facilitate the accessing of customer dynamics data and location information of customers and processing this information by an analytical infrastructure in order to identify preferred customers.

Pharmaceutical sales representatives today have to deal with the burden of analyzing marketing dynamics and statistical data to prioritize customers to contact to promote the sale of a pharmaceutical product. A customer may be a health care practitioner, customer, prescriber, pharmacist or hospital personnel. Each individual pharmaceutical representative may carry out their own research into the marketing dynamics and makes individualized interpretations of the data to generate his or own call plan for a certain period. Pharmaceutical sales representatives may therefore make decisions, on the priority of customers based on their interpretations of the data. This process may be both time consuming, and in some instances, inefficient. The decisions made of sales representatives may be based on outdated data, or partial data and may not be optimally obtained. The decisions on the priority of customers arrived by sales representatives in these instances may also not be repeatable or accurate.

The operations described herein allow pharmaceutical sales representatives to have access to live marketing dynamics data and location data. Pharmaceutical sales representatives may use the live data and location today to prioritize customers to call or visit to promote a pharmaceutical product. Pharmaceutical sales representatives may use an analytical infrastructure for managing customer call plans and visit schedules. The analytical framework developed may be implemented on a webpage or as a mobile application and used by pharmaceutical sales representatives to manage customer call plans and identify a next best customer to contact to promote a product.

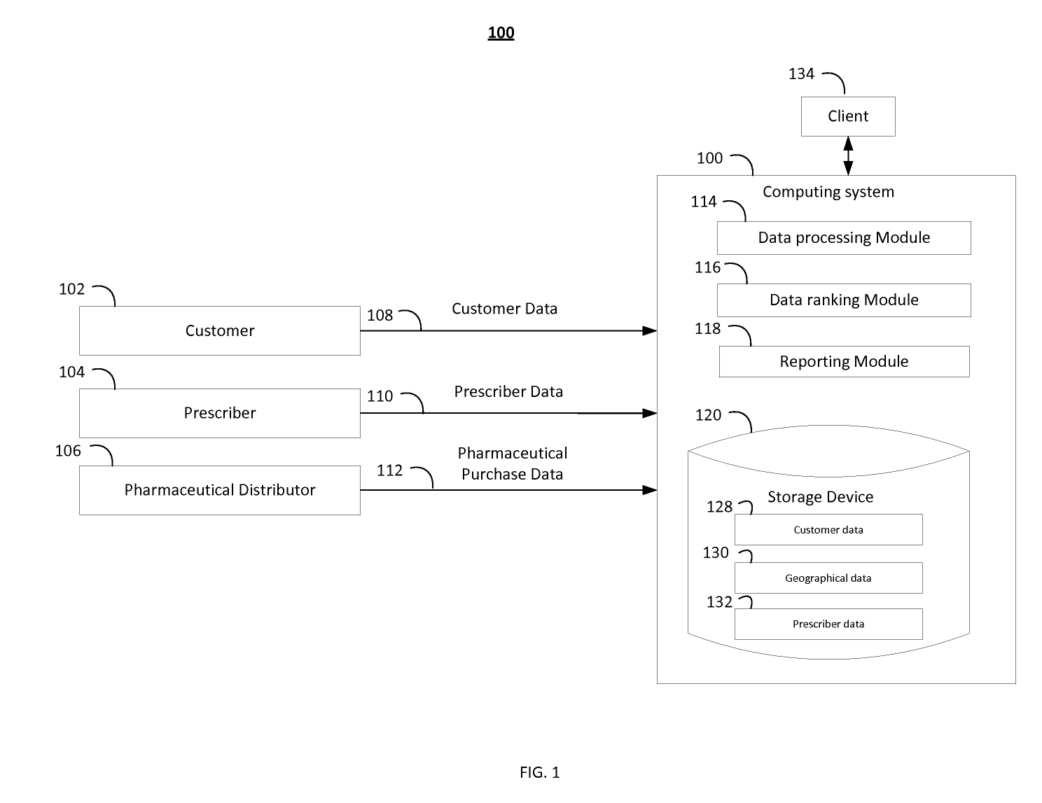

FIG. 1 illustrates an example analytical infrastructure system implemented in a computing system 100. The computing system may be implemented as a data processing apparatus that is capable of providing the functionality discussed herein, and may include any appropriate combination of processors, memory, and other hardware and software that can receive appropriate medical data and process the data as discussed below. At a high-level, the illustrated example computing system 100 receives various data from sources that are participants in the healthcare process. The sources may include customer system 102, prescriber system 104, and pharmaceutical distributor system 106. The data may include customer data 108, prescriber data 110 and pharmaceutical purchase data 112. In some implementations, the data may include social media data.

FIG. 1 illustrates the process by which an analytical infrastructure is able to integrate customer dynamics data received, for example, from customer system 102 or from prescriber system 104, with other data sources available in IMS, such as pharmaceutical distributor systems 106. The data from customer system 102 may include any data for a customer. A customer may be a health care practitioner, customer, pharmacist or hospital personnel. The data may include a customer profile, the customer profile may include the customer contact information, the customer specialty, the customer class decile and the customer Integrated Delivery Network (IDN) affiliations and or health care system, if any. The customer profile may include a customer's, affiliations, authorization data (e.g., DEA, AOA, SLN, and/or NPI numbers). The customer data may also include the exact address of the customer or may include the zip code of the customer.

The data from prescriber system 104 may include data for a customer, in the case where the customer is a prescriber. The prescriber data 110 may include the prescription data of the prescriber. The prescriber data may represent data reflecting all prescriptions for pharmaceutical products issued by physicians or other health care practitioners within the one or more IDNs or health care systems, including information about the type of prescription used to obtain the product and the payment method used to purchase the product. The prescription data may include the total revenue spent on prescriptions based on the specific drug. In some implementations, the data may be based on the total revenue spent on a specific drug in a specific geographic location. In the case where prescription data is related to a patient, the patient data remains confidential. It is important to understand that the system may be configured to preserve patient privacy, and will not store nominative data in an aggregated database but only de-identified data. Nominative data for an individual can be compared to the relevant aggregated data, but this may be achieved by using aggregated values in the individual patient application, not by keeping nominative records for multiple patients in a single database. Also, the integration of data from sources other than the user and their medical professionals may be achieved on a de-identified basis except in the instance that the individual gives permission to use their identity information (name, location, gender and age) for the purpose of providing them with their information from another source.

The pharmaceutical purchase data 112 may include information about pharmaceutical purchases made from distributors 106 (e.g., pharmaceutical wholesalers or manufacturers). For example, the pharmaceutical purchase data 112 may include information about the outlet from which a pharmaceutical product is purchased, the type of pharmaceutical product purchased, the location of both the purchaser and seller of the pharmaceutical product, when the purchase was conducted, and/or the amount of a pharmaceutical product that was purchased. Though FIG. 1 illustrates the pharmaceutical purchase data 112 as being received by the computing system 100 directly from one or more distributors 106, the pharmaceutical purchase data 112 may be collected by one or more other systems and then provided to the computing system 100. Moreover, the pharmaceutical purchase data 112 may not originate from the one or more distributors 106, but rather be provided by the purchaser of the pharmaceutical product (e.g., a retail outlet).

The various types of data just discussed, which may include customer data 108, prescriber data 110 and pharmaceutical purchases data 112, are received by computing system 100 in order to derive conclusions based on the data. As noted previously, by the time the data is received by computing system 100, it should have been sanitized so that the data does not include private or confidential information that computing system 100 should not able to access.

For illustrative purposes, computing system 100 will be described as including a data processing module 114, a data ranking module 116, a reporting module 118, and a storage device 120. However, the computing system 100 may be any computing platform capable of performing the described functions. The computing system 100 may include one or more servers that may include hardware, software, or a combination of both for performing the described functions. Moreover, the data processing module 114, the data ranking module 116, and the reporting module 118 may be implemented together or separately in hardware and/or software. Though the data processing module 114, the data ranking module 116, and the reporting module 118 will be described as each carrying out certain functionality, the described functionality of each of these modules may be performed by one or more other modules in conjunction with or in place of the described module.

The data processing module 114 receives and processes one or more of customer data 108, prescriber data 110 and pharmaceutical data 112. In processing the received data, the data processing module 114 may filter and/or mine the customer data 108, prescriber data 110 and pharmaceutical data 112 for specific information. The data processing module 114 may filter and/or mine the received retail customer data 108, prescriber data 110 and pharmaceutical data 112 for specific pharmaceutical products. Thus, any received customer data 108, prescriber data 110 and pharmaceutical data 112 that regards pharmaceutical products that are not classified as being associated with a tracked compound or prescription may be disregarded. For example, the received data may be processed by data processing module 114 so as to track a specific pharmaceutical product, for example Lasix, or to track a class of products used to serve a condition.

After processing the received customer data 108, prescriber data 110 and pharmaceutical data 112, the data processing module 114 aggregates the processed data into customer data 128, geographical data 130, and prescriber data 132. These groups of data may be stored in storage device 120. In some implementations, the data processing module 114 may create profiles for each product, prescriber, and pharmaceutical distributor for which data is received.

In other implementations, the data processing module 114 may simply sort and store, in storage device 120, processed prescriber data 110, customer data 110, reference prescriber data 114, pharmaceutical purchase data 112, the data processing module 114 for later use by other modules.

The prescriber data 110 or pharmaceutical purchase data 112 may include any information related to the prescription and/or sale of one or more types of pharmaceutical products. Pharmaceutical purchase data 112 may include the quantity of each type of pharmaceutical product patients have purchased, the number and/or name of doctors from which the patient has received scripts, the number and/or name of retail outlets from which the patient has purchased pharmaceutical products, and/or information regarding the payment method(s) used by the patient when purchasing pharmaceutical products (e.g., cash or insurance).

The prescriber data 110 received from the prescriber system 104, may include any information related to prescriptions written by an identified prescriber for one or more types of pharmaceutical products and the patients to whom the prescriptions were written. Prescriber data 110 may include the quantity of one or more types of pharmaceutical products for which the prescriber has written a prescription, the percentage of prescriptions for one or more types of pharmaceutical products written by a prescriber in relation to the total number prescriptions written by the prescriber, the percentage of prescriptions for one or more types of pharmaceutical products that are paid for with cash, and/or the number of patients for whom the prescriber has written a prescription for one or more types of pharmaceutical products and who currently have a supply of the one or more types of pharmaceutical products that exceeds a threshold. Prescriber data 110 may also include information about which IDN or health care system the prescriber is affiliated with, if any.

The data ranking module 116 uses the customer data 108, prescriber data 110 and pharmaceutical data 112 to rate and rank individual customers and/or prescribers. In some implementations, data ranking module 116 may compare one or more elements of the customer data 108 to the one or more elements of the pharmaceutical data 112 across a set time period. Based on the comparison of the one or more elements of the customer data 108, the data ranking module 116 may assign one or more ratings to a customer. The data ranking module 116 may assign a rating to a customer that reflects how likely the customer is to purchase a particular pharmaceutical product. Customers in the set used in the comparison may be customers in the same location (e.g., country, state, city, or zip code), customers who share similar specialties and/or patients who share some other relationship.

The ratings assigned to a customer by the data ranking module 116 may be normalized numbers that reflect the analysis performed with regard to an element of the customer data 108, prescriber data 110 and pharmaceutical data 112. In some implementations, the ratings determined by the data ranking module 116 may be updated on a periodic basis (e.g., weekly or monthly) or updated any time new data regarding the element corresponding to the rating is received by the computer system 100. Alternatively, in some implementations, the ratings determined by the data ranking module 116 may be calculated every time data ranking module 116 receives a query for the ratings.

The data ranking module 116 may also calculate a composite rating for each patient, prescriber, and/or retail outlet for which data has been received by the computer system 100. In some implementations, the data ranking module 116 may weight each of the individual element ratings associated with a customer, prescriber, or pharmaceutical distributor and apply an equation to calculate a composite of the individual element ratings. Alternatively, in some implementations, the data ranking module 116 may select a proper subset of the available individual element ratings and calculate a composite rating based on the selected individual element ratings.

The reporting module 118 prepares reports based on the ratings and/or rankings calculated by the data ranking module 116. The reports prepared by the reporting module 118 may include one or more of the ratings calculated by the data ranking module 116 as well as any other data contained in the customer data 108, prescriber data 110 and/or pharmaceutical purchase data 112. For example, a report generated by the reporting system may include composite ratings for all customers in a given state for a particular pharmaceutical product (e.g., oxycodone—a controlled substance).

The system shown may be filtered and/or mined based on any one or more criteria associated with a customer and/or pharmaceutical distributor. The reports may be filtered and/or mined based on location, type pharmaceutical product, medical specialty of a customer, and or one or more ratings calculated by the data ranking module 116. In other words, any data received and processed by the data processing module 114 or any ratings or rankings calculated by the data ranking module 116 may be included in or used to filter and/or mine the data included in a report.

Additionally, in some implementations, the reports generated may be either dynamic or static. The reporting module 118 may generate a report that includes data presented in one or more static formats (e.g., a chart, a graph, or a table) without providing any mechanism for altering the format and/or manipulating the data presented in the report. In such an implementation, the data presentation is generated and saved without incorporating functionality to update the data presentation. In some implementations, the reporting module 116 provides a static report in a PDF, spreadsheet, XML, PPTX or PPT, or Keynote format. Such a format generally provides an understanding of the reporting module 118 as textual data or a visualization, but other forms of presenting conclusions such as audio, video, or an animation are not excluded as potential results from reporting module 118.

Additionally or alternatively, the reporting module 118 may generate a report that includes controls allowing a user to alter and/or manipulate the report itself interactively. For example, the reporting system may provide a dynamic report in the form of an HTML document that itself includes controls for filtering, manipulating, and/or ordering the data displayed in the report. Moreover, a dynamic report may include the capability of switching between numerous visual representations of the information included in the dynamic report. In some implementations, a dynamic report may provide direct access as selected by a user to some or all of the customer data 108, prescriber data 110 and/or pharmaceutical purchase data prepared by the data processing module 114 and/or the data ranking module 116, as opposed to allowing access to only data and/or ratings included in the report itself.

One or more clients 134 may interface with the computing system 100 to request and receive reports created by the reporting system. In some implementations, the one or more clients 134 may include a web browser that provides Internet-based access to the computing system 100. Through the web browser, a user of a client 134 (e.g., a wholesaler, a retail outlet, or a customer) may request a static or dynamic report from the reporting system as discussed above.

There may be any number of clients 134 associated with, or external to, the example computing system 100. While the illustrated example computing system 100 is shown in communication with one client 134, alternative implementations of the example computing system 100 may communicate with any number of clients 134 suitable to the purposes of the example computing system 100. Further, the term “client” and “user” may be used interchangeably as appropriate without departing from the scope of this disclosure. Moreover, while the client 134 is described in terms of being used by a single user, this disclosure contemplates that many users may share the use of one computer, or that one user may use multiple computers.

The illustrated client 134 is intended to encompass computing devices such as a desktop computer, laptop/notebook computer, wireless data port, smartphone, personal digital assistant (PDA), tablet computing device, one or more processors within these devices, or any other suitable processing device. For example, the client 134 may include a computer that includes an input device, such as a keypad, touch screen, or other device that can accept user information, and an output device that conveys information associated with the operation of the computing system 100. The input device may be used by client 134 to provide instructions to computing system 100 that computing system 100 can execute to provide information requested by client 134 from the various data that computing system 100 receives.

In some implementations, functionality described as being performed by the computing system 100 may be performed by the client 134. For example, the computing system 100 may provide a client 134 with direct access to the ratings and rankings calculated by the data ranking module 116. As a result, some or all of the functionality described as being performed by the reporting module 118 may be performed locally by the client 134. The analytical infrastructure may be supported on a webpage application that a client may use to view the data received by the computing system at the analytical infrastructure.

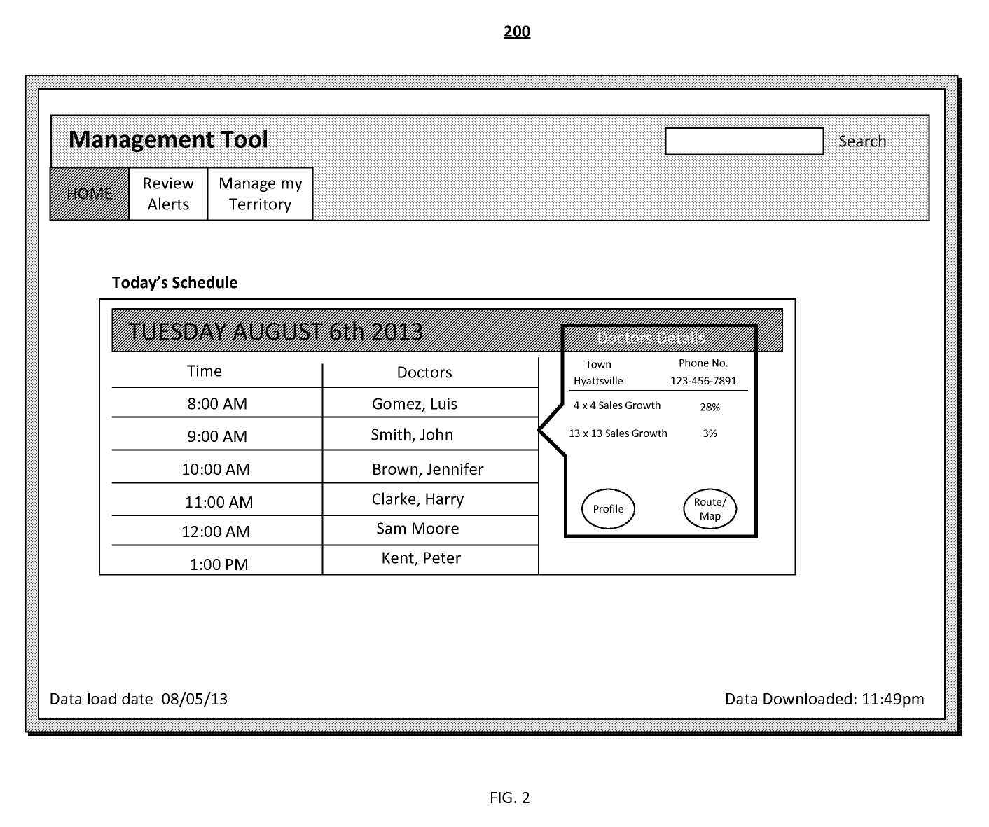

FIG. 2 is an example user interface 200 that illustrates the homepage of a web application for a schedule management tool. Interface 200 may be displayed when a user, a pharmaceutical sales representative, logs into a secure connection with the schedule management tool. The user may log into the schedule management tool system, by providing a user specific user name and password. The schedule management tool system then generates the homepage as illustrated in FIG. 2. The homepage is specific to the individual users of the schedule management tool system, that is, the homepage generated is specific to a pharmaceutical sales representative. In some implementations, the user may have the option to customize the information displayed on the homepage. In these implementations, the homepage may include a “Customize Page” tab displayed on the homepage.

The homepage may display the sales representative's schedule for contacting customers to promote a pharmaceutical product. The homepage may display a calendar showing the days in the present work week and may highlight “today's schedule.” The homepage of the schedule management tool may sync with the sales force automation (SFA) appointments to links analytics to customers listed in the schedule. The schedule may list the times of an appointment and the name of the customer associated with the appointment. The homepage may also display data updates, for example, the homepage may display the data download time and date. The data download date and time serve as an indicator to the user to ensure that the data displayed has recently been downloaded. In some implementations, if the data download time is greater than 2 hours, the system generates an alert to the user.

The user may select a customer's name on the schedule to view more details about the customer. A customer may be a physician, health care practitioner, pharmacist or hospital personnel. The customer details may include the geographic location of the customer, the customer's contact information, and a link to the customer's complete profile. In some implementations, the customer detail may include prescriber behavior of the customer. For example, the customer details may include the total number of prescriptions for a particular product written by the prescriber. The customer detail may display the prescriber's market share based on the number of prescriptions written.

The schedule management interface may include one or more tabs. For the example, illustrated in FIG. 2 the tabs include a “review alerts” tab, and a “manage my territory” tab. In some implementations, the interface may include a “assess my performance” tab and a “address my performance” tab. The “assess my performance” tab may display details of the sales representative's performance over a specified time period. For example, the sales representative's performance could be ranked based on the performance of the other sales representatives promoting a product. The “assess my performance” tab may also include further details on the sales representative's performance. For example, it may include details on the number of sales the representative must reach to meet a target number of sales.

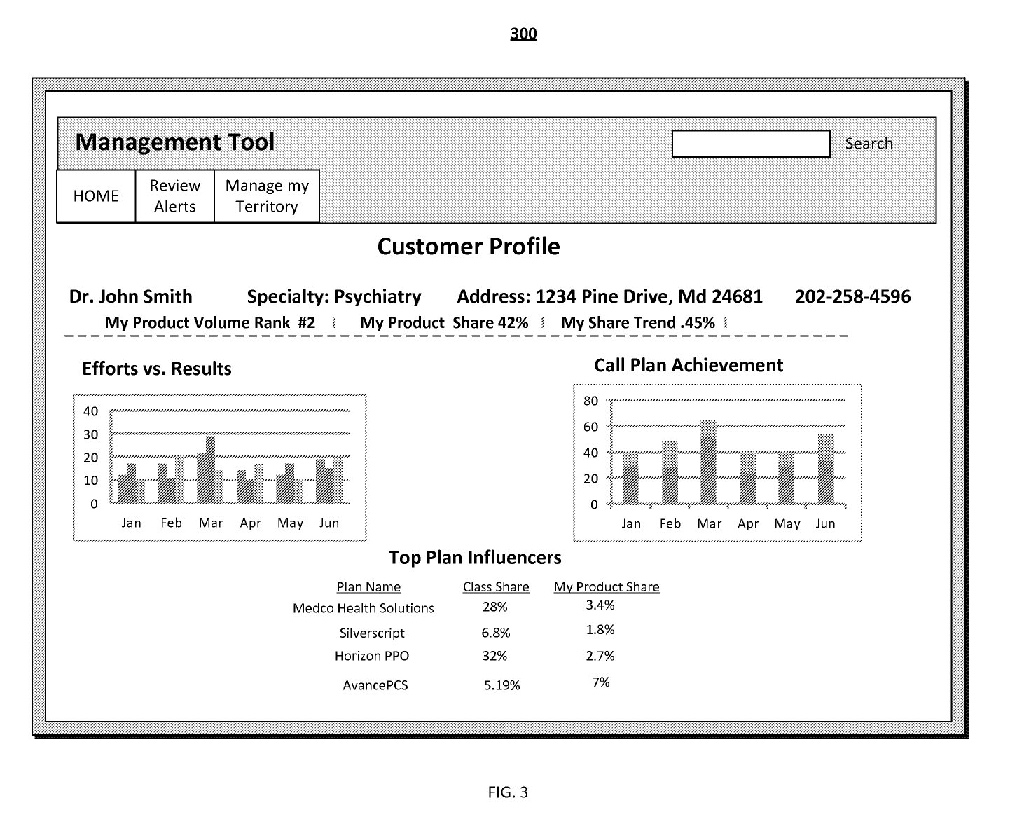

FIG. 3 illustrates an example user interface 300 that shows the customer profile of a selected customer. FIG. 3 may be displayed when a user selects the profile tab in the doctors detail pop up. The customer profile may be dynamically generated and include details about the customer, that may be used to inform the sales representative about the customer. The customer profile may include the customer's name and title. For the example displayed in FIG. 3, the customer profile includes the customer name Dr. John Smith and his specialty Psychiatry. The customer profile may include the address of the customer and the customer's phone number.

The customer profile may include a “my product volume rank,” the product volume rank may be based on the volume of sales the customer contributes to the sales representative's total sales volume. For the example illustrated in FIG. 3, Dr. John Smith is ranked as number 2 based on the sales representative's total sale volumes. The customer profile may include a “my product share,” the product share rank may be based on the product share the customer contributes to the sales representative's total product share. For the example illustrated in FIG. 3, Dr. John contributes 42% to the sales representative's product share. The customer profile may also include a “my share trend.” In some implementations, the sales representative user may have the ability to customize the information that is displayed on a customer's profile page. For example, the user may select to display to display only the customer's name, address and product share.

The customer profile may include one or more charts or graphs that illustrate data to the sales representative user in a clear and precise manner. For the example illustrated in FIG. 3, the “Efforts vs. Results” chart illustrates the total number of sales made by the sales representative versus the number of free samples distributed to the identified customer and the number of calls made by the sales representative. The customer profile may also include a chart that displays a call plan achievement. The chart may illustrate the number of plans calls to the customer and the number of projected calls and actual calls. In some implementations, the chart may also display the percentage call achievement for the customer.

The customer profile may also include a chart that displays the top Integrated Delivery Networks (IDNs) or health care systems that are affected by the customer. In some implementations the chart may display the payer entity that is affected by the customer. In some implementations, a payer and an Integrated Delivery Network (IDN) or health care system may be a single entity that both provides the medical services to a patient and pays for the medical services received by a patient. In other implementations however, the payer is a separate entity other than the IDN. In these implementations, the IDN or health care system also may act as the provider group where the medical services are provided to a patient such that the payer is entity that covers at least a percentage of the cost of the medical services received by a patient. A payer also may be a private insurance company that covers the medical expenses of a patient, or the payer may include the government, for example, when the patient is covered by Medicaid. The IDN or provider group may include a corporate group, or a government-owned facility. In some examples, an IDN or health care system may include a non-profit organization, such as an insurance cooperative that is sponsored or assisted by the government. A chart that shows the top IDN or payers influenced by the customer may indicate to a pharmaceutical user the influence rating of a customer. In some implementations, the data displayed on the customer profile may include the class decile ranking of the customer.

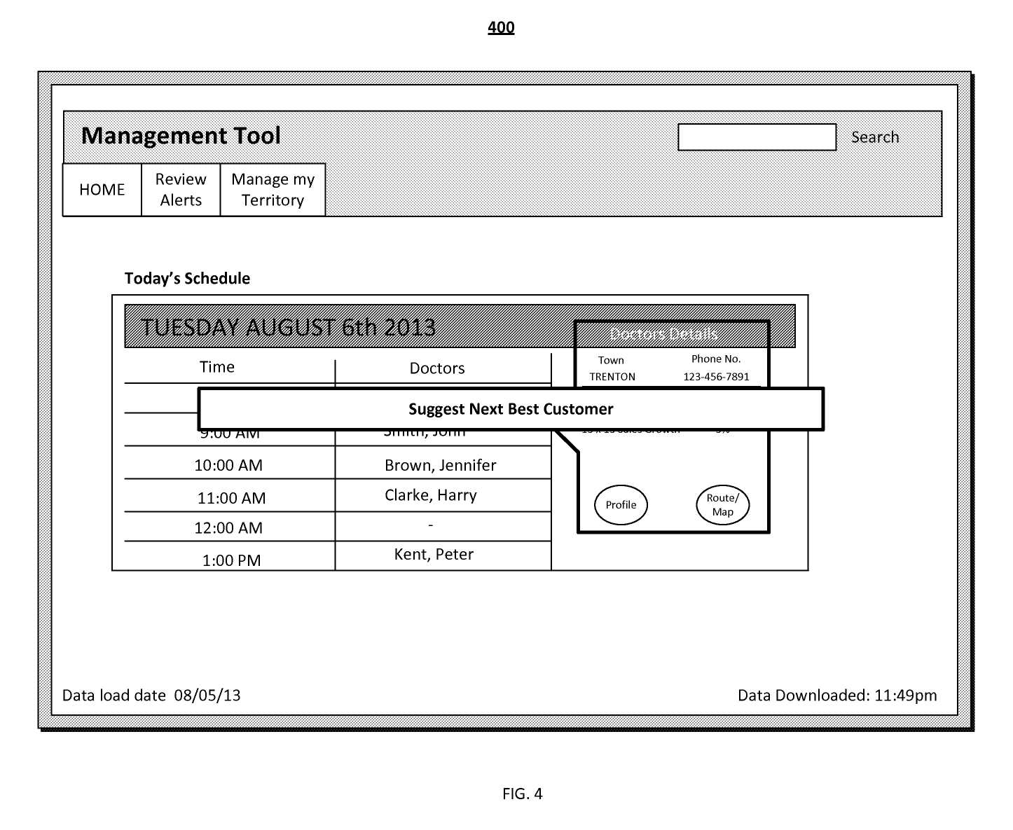

FIG. 4 illustrates an example user interface 400 that illustrates the homepage of a web application for a schedule management tool. Interface 400 may be displayed when a user, a pharmaceutical sales representative, logs into a secure connection with the schedule management tool. The user may log into the schedule management tool system, by providing a user specific user name and password. The schedule management tool system then generates the homepage as illustrated in FIG. 2. The homepage is specific to the individual users of the schedule management tool system, that is, the homepage generated is specific to a pharmaceutical sales representative. The user specific information may include a call list of customer and the associated relative visit data. In some implementations, the user may have the option to customize the information displayed on the homepage. In these implementations, the homepage may include a “Customize Page” tab displayed on the homepage.

The homepage may display the sales representative's schedule for contacting customers to promote a pharmaceutical product. The homepage may display a calendar showing the days in the present work week and may highlight “today's schedule.” The homepage of the schedule management tool syncs with the sales force automation (SFA) appointments to link analytics to customer listed in the schedule. The schedule may list the times of an appointment and the name of the customer associated with the appointment. The homepage may also display data updates, for example, the homepage may display the data download time and date. The data download date and time serve as an indicator to the user to ensure that the data displayed has recently been downloaded. In some implementations, if the data download time is greater than 2 hours, the system generates an alert to the user.

For the example illustrated in FIG. 4, the user's schedule may have an opening at one of the time slots, for example at 12:00 pm. The sales management tool identifies an opening in the user's schedule for today. In some implementations, the sales management tool may generate a pop up window across the screen of “today's schedule,” to alert the user of the opening in his or her schedule. In some implementations, the sales management tool may generate a selectable tab for the user to select to generate a list of potential customers. For the example illustrated in FIG. 4, the sales management tool may generate a “suggest next best customer” tab. In some implementations, the sales management tool may generate a “suggest next best customer” tab each time the sales representative's schedule is displayed. In these implementations, the sales representative may be able to change his or her schedule if the computing systems at the analytical tool identify a customer that may be more profitable to visit.

In some implementations, the computing systems at the analytical infrastructure may identify a cancellation of an appointment in the sales representative's schedule. The computing systems at the analytical infrastructure may access data from the scheduling systems at one or more customers and may identify if a customer cancels an appointment with the sales representative. In these implementations, the sales management tool may generate a tab that the sales representative user may select to generate a list of one or more potential customers to contact during the newly opened appointment time. The computing systems at the analytical infrastructure may cancel an appointment listed in the “today schedule” and suggest a list of potential “next best customers” to contact. The computing systems at the analytical infrastructure may identify a customer included in the “today's schedule” may not be a customer the sales representative should contact. For example, the computing systems at the analytical infrastructure may identify, based on the geographical location information, that a customer may be located further than a predetermined maximum distance from the geographical location of the previous appointment. The computing systems at the schedule management tool may then identify potential customers closer to the geographical location of the previous appointment for the sales representative to visit. In these implementations, the computing systems at the analytical infrastructure may suggest that the sales representative change the appointment to a phone call instead of an in person visit if the geographical location of the appointment is identified to be further than the predetermined maximum distance.

In some implementations, the computing systems at the analytical infrastructure may generate a full schedule for the sales representative. The computing systems may identify a day in the sales representative's schedule that has yet been occupied with appointments. For example, the sales representative's schedule for two weeks at the end of the present month may still be open. The computing systems at the analytical infrastructure may generate a schedule for a given day based on identifying potential customers for the sales representative to contact. In some implementations, the computing systems at the analytical infrastructure may generate the list of potential customers based on different targets set by the sales representative user. For example, the sales representative user may set a target of contacting and/or visiting 10 new customers each month. The list of potential customers generated by the analytical infrastructure may include one or more new customers. The system may identify 2 new customers for each day of the week to satisfy the sales representative's target of 10 new customers for the month. In some implementations, the sales representative user may be able to adjust targets each month. In other implementations, the targets for the type of customers to be visited and/or called by a sales representative may by management.

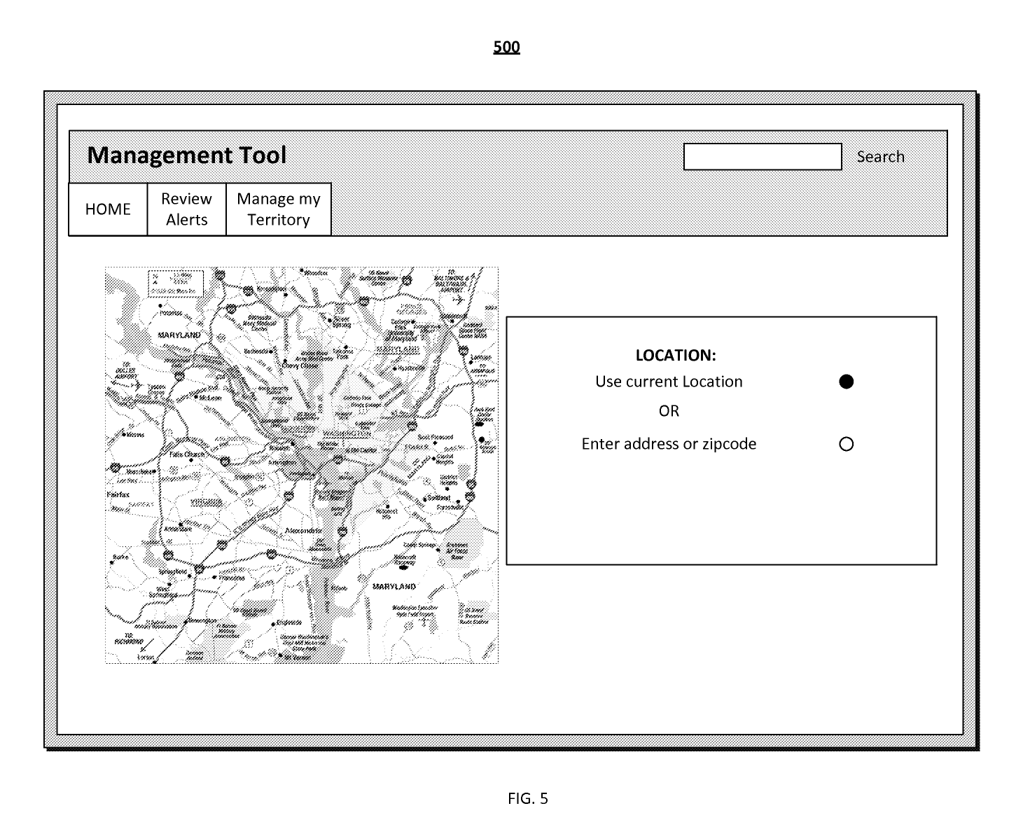

FIG. 5 illustrates an example user interface 500. FIG. 5 may be displayed when a user selects the “suggest next best customer” tab as illustrated in FIG. 4. The computing systems at the schedule management tool may generate the map displayed in interface 500 by using accessed geographical location information. The interface allows a user to select a location, the location selected by the user will be used by the computing systems at the schedule management tool to suggest potential customers to the sales representative user. In some implementations, the user is promoted to use his or her current location or the user may enter the address or zip code of another location.

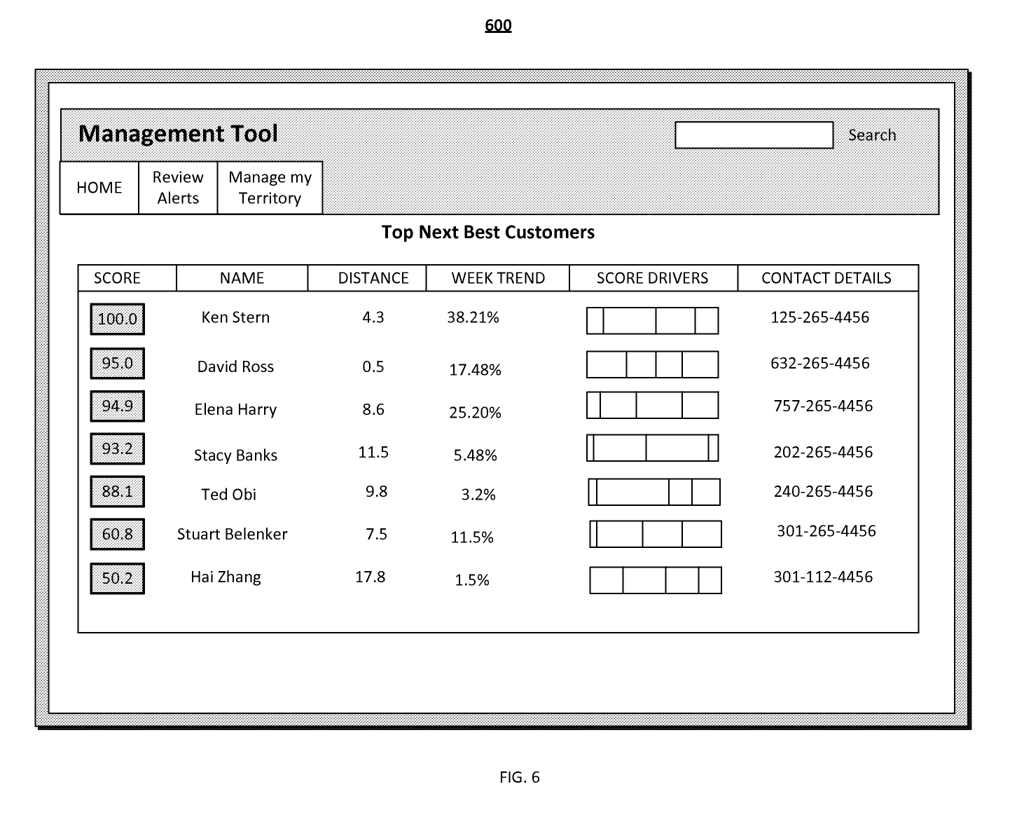

FIG. 6 is an example user interface 600 that illustrates the list of the top next best customers. FIG. 6 may be displayed when the user selects his or her location as illustrated in FIG. 5. Interface 600 displays the top seven next best customers. In this implementation, the computing systems at the analytical infrastructure only rank customers that have a customer score higher than 50%. In some implementations, the computing systems at the analytical infrastructure may rank all potential customers and may display list of twenty potential customers. For the example illustrated in FIG. 6, Ken Stern is ranked as the top next best customer with a customer score of 100. In some implementations, the top customer score may be 10. The list includes the customer score, the name of the customer, the distance of the customer from the location of the sales representative, the weekly trend, the contact details of the customer and the score drivers.

The list is generated based on the customer score, the score is assigned to a customer based on the accessed customer dynamics data and geographical location data. The customer dynamics data may include customer data, prescriber data and pharmaceutical purchase data. The customer data may include any data about a customer such as the customer profile. The customer profile may include customer contact information, the customer specialty, the customer decile rating and the customer's IDN affiliations, if any. The customer data may also include the influence and favorability of the IDN the customer is affiliated with.

The prescriber data may represent data for all pharmaceutical products prescribed by the customer. The prescription data may include the total revenue spent on prescriptions based on a specific drug. The pharmaceutical purchase data may include information about pharmaceutical purchases made from distributors. Pharmaceutical data may include, for example, information about the outlet from which the product was purchased, the type of product purchased, the location of both the purchaser and seller of the product, when the purchase was conducted and the amount of product that was purchased. The data processing module 116 at the computing systems of the analytical infrastructure may parse the customer data, the prescriber data and the pharmaceutical purchase data and categorizes the data into two or more categories. The four categories the customer dynamics data is categorized into are: customer dynamics, practicality, opportunity and strategic focus. For example, customer location and customer specialty information may be categorized into the practicality category. The data ranking module then assigns a weighted score to the attributes of the customer dynamics data that is categorized as affecting practicality. For example, a customer's location and specialty information may be used to assign a practicality score of 80%. The data ranking module then assigns a weighted score to the other three categories. The data ranking module then assigns a customer store based on a weighted average of the four customer dynamics data sub-categories. In some implementations, all four categories have equal weight. For example, the customer score is based on customer dynamics contributing 25%, practicality contributing 25%, opportunity contributing 25% and strategic focus contributed 25%. In other implementations, the weights of the four categories may not be equal. In these implementations, the sales representative using the schedule management tool may be able to customize the weights of the categories based on personal preference.

In some implementations, the computing systems at the analytical infrastructure may identify potential customers based on one or more targets for the type of customers to contact. For example, the sales representative may have a target of calling 10 new customers each month. As another example, a sales representative may have a target of contacting recurring customers at least once every month. In some implementations, sale representative targets may be a category that contributes to the customer score. In these implementations, the sales representative may adjust the weight of targets on the overall customer score. In other implementations, the targets are personal goals set by the sales representative and may not be used to calculate a customer score. Still in other implementations, these settings may be standardized and frozen by the organization's home office.

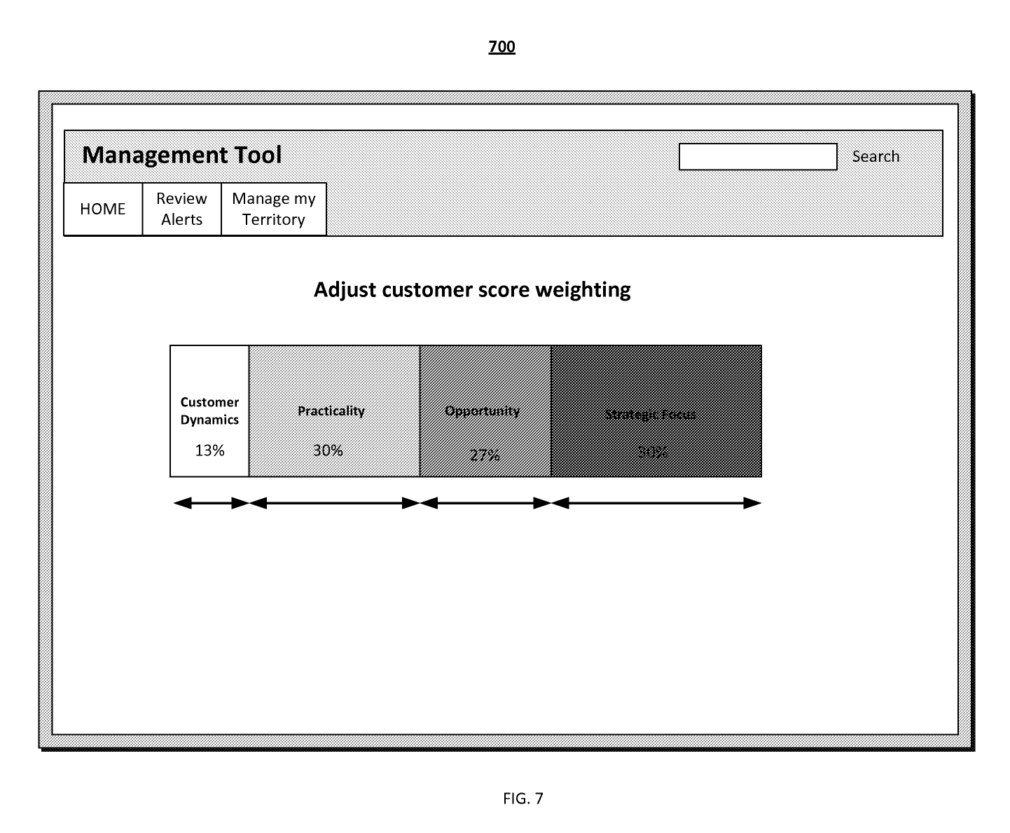

FIG. 7 is an example user interface 700 that illustrates a scale for adjusting customer score weighting. FIG. 7 may be illustrated when a customer selects the score drivers tab as illustrated in FIG. 6. In some implementations, the weighting for the calculation of the customer score may be standard. In other implementations, the weighting for the calculation of the customer score may be customized. In these implementations, the schedule management tool may prompt the user to set the weighting of the factors before generating a next best customer listing. For example, interface 700 may be displayed prior to the generation of the list and the user may alter the percentage weight of each field. For the example illustrated in FIG. 7, the customer dynamics is set to a weight of 13% of the customer score. The sales representative may select the arrow associated with the customer dynamics tab to either increase or decrease the weight. The other factors may also be adjusted in a similar manner. In some implementations, as the sales representative user adjusts the weighting of the factors the schedule management tool may modify the top next best customer list dynamically. The top next best customer may be highlighted as the sales representative user adjusts the weights. For example, Dr. Ross may be ranked as the top next best customer and as the user adjusts the practicality weighting to 20%, Dr. Kim may move to the top of the list.

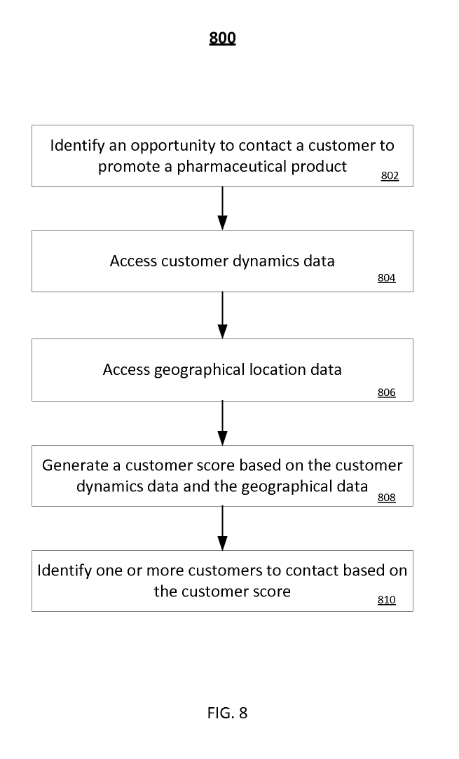

FIG. 8 is a flow chart of a process by which an analytical infrastructure uses customer dynamics data and geographical location data to generate one or more customers to contact based on customer score.

The computing systems at the analytical infrastructure identify an opportunity to contact a customer to promote a pharmaceutical product (802). The computing systems at the analytical infrastructure may access the sales representative's schedule information. In some implementations, the sales representative's schedule is accessed from data downloaded from the sales force automation system (SFA). In others implementations, the sales representations enters his or her schedule information into the “today's schedule” table displayed on the home page, as illustrated in FIG. 2. The analytical infrastructure may recognize that there is an opening in the sales representative's schedule and identify this as an opportunity to contact a customer to promote a pharmaceutical product. In other implementations, the analytical infrastructure may recognize that an appointment in the sales representative's schedule may have recently been changed or cancelled. For example, a sales representative may have cancelled an appointment with a customer or other health care practitioner after evaluating that the visit to the customer or health care practitioner may not have profitable. In further implementations, the analytical infrastructure may be linked to the customer's or health care practitioner's scheduling system and may access the physicians schedule information. In this implementation, the computing systems at the analytical infrastructure may identify if a customer or health care practitioner has cancelled an appointment with a sales representative causing an opening in the sales representative's schedule. In some implementations, the computing systems at the analytical infrastructure may not access the sales representative's schedule information.

The computing systems at the analytical infrastructure access customer dynamics data (804). The customer dynamics data may include data customer data 108, prescriber data 110 and pharmaceutical purchase data 112 that may be accessed by the computing systems at the analytical infrastructure. The customer data may include any data about a customer; a customer may be a health care practitioner, pharmacist or hospital personnel. The customer data may include a customer profile, the customer profile may include the customer contact information, the customer specialty, the customer class decile rating and the customer's Integrated Delivery Network (IDN) affiliations, if any. The customer profile may include a customer's, affiliations, authorization data (e.g., DEA, AOA, SLN, and/or NPI numbers). The customer data may also include the exact address of the customer or may include the zip code of the customer. In the implementations where the customer data includes the customer's affiliations to an IDN or health care system, the customer data may include the details on the influence of the IDN or health care system the customer is affiliated with. The customer data may further include the favorability of the IDN or health care system the customer is affiliated with. The favorability of an IDN can be described as the relative level of a performance of the IDN or health care system compared to the performance of non-member physicians within the same geographical area. The favorability of an IDN may be determined within a geographical area, in some instances the geographical area may be a postal zip code or the geographical area may be a city.

The prescriber data 110 accessed may include the prescription data of the prescriber. The prescriber data may represent data reflecting all prescriptions for pharmaceutical products issued by physicians, including information about the type of prescription used to obtain the product and the payment method used to purchase the product. The prescription data may include the total revenue spent on prescriptions based on the specific drug. In some implementations, the data may be based on the total revenue spent on a specific drug in a specific geographic location. In the case where prescription data is related to a patient, the patient data remains confidential. It is important to understand that the system may be configured to preserve patient privacy, and will not store nominative data in an aggregated database but only de-identified data. The prescription data may further include any other information on the prescribing habits and trends of customers.

The pharmaceutical purchase data accessed may include information about pharmaceutical purchases made from distributors 106 (e.g., pharmaceutical wholesalers or manufacturers). For example, the pharmaceutical purchase data 112 may include information about the outlet from which a pharmaceutical product is purchased, the type of pharmaceutical product purchased, the location of both the purchaser and seller of the pharmaceutical product, when the purchase was conducted, and/or the amount of a pharmaceutical product that was purchased. The pharmaceutical purchase data may include data. In addition, customer dynamics data may further include data that is accessed from historical sales data specific to the sales representative. For example, the customer dynamics data may include the history of successful visits to a customer by the sales representative, and the number of phone calls made to the customer recently as well as the number of free samples distributed to the customer.

The computing systems at the analytical infrastructure access geographical location data (808). The computing systems may access the geographical location from address data in a customer profile. The geographical location data may also be accessed from other contact information. For example, the customer's telephone number may be used to identify the address associated with the telephone number. The computing system at the analytical infrastructure may access the sales representative's present location. The location information may be accessed from the Global Position System (GPS) on the computing device that is running the schedule management software.

The computing systems at the analytical infrastructure generate a customer score based on the customer dynamics data and the geographical data (810). The computing systems at the analytical computing systems used the accessed customer dynamics data and the accessed geographical data to determine a standardized rating of potential customers to visit. Generating a standardized rating allows sales representatives to efficiently use data available to make an informed decision on what customer would be the best to visit during an open time. In some implementations, the customer score may be based on four categories, that is, customer dynamics, practicality, opportunity and strategic focus. In other implementations, the customer score may be based on other categories.

As described earlier, customer dynamics data may include customer data, prescriber data and pharmaceutical purchase data. This data may be accessed by the computing systems at the analytical infrastructure and used to determine for each specific customer, the rating for each category used to determine the customer score. Practicality ratings may be determined based on the geographical distance between the sales representative and the customer. Practicality ratings may also be evaluated in terms of the customer's specialty, practically ratings maybe specific to the sales representative and the particular product being promoted. For example, a plastic surgeon may have a low practicality rating for a sales representative promoting a drug which is used to treat diabetes. The customer dynamics rating may be evaluated based on the prescribing habits of the customer, the total number of prescriptions written by the prescriber, the influence of the IDN or health care system the customer is associated with and the favorability of the IDN or health care system the customer is associated with. The customer dynamics rating may also be based on any other type of customer dynamic data that is, for example stored in IMS data. In some implementations, the customer dynamic rating may also be based on not only IMS data but also third part supplied data that partner with customers IMS may serve with the current methodology. Opportunity ratings may be evaluated based on the schedule of the customer. For example, the opportunity rating for visiting a physician on a Tuesday, even though the physician only has office hours on a Thursday, may be low. The strategic focus rating may be based on historical sales data specific to the pharmaceutical sales representative. For example, the number of times the sales representative has visited the customer recently, the number of times the visits have been successful, the number of free samples distributed to the customer and/or the number of calls made to the customer.

The pharmaceutical sales representative may, in some instances, have the ability to customize the categories used to generate the customer score. The pharmaceutical sale representative may also have the ability to customize the weight of each category on the overall customer score generated. The standard customer score may be generated based on each category of the customer score having equal weight. For example each of the four categories, customer dynamics, practicality, opportunity and strategic focus may have a weight of 25% on the resultant customer score. The pharmaceutical sales representative may choose to customize the weights such that practicality is heavier weighted than strategic focus. For example, customer dynamics may have a weight of 25%, practicality 45%, opportunity, 25% and strategic focus 5%.

The computing systems at the analytical infrastructure identify one or more customers to contact based on the customer score (812). In some implementations, the computing systems at the analytical infrastructure may generate a ranked list of customers to contact. The list may be ranked by the customer score associated with the customer. For example, the customer with the highest customer score may be positioned at the top of the generated list and customers with lower scores may be listed below. In some implementations, the generated list may be limited to the top ten or twenty customers. In other implementations, the list may only include customers with a customer score that is higher than a predetermined limit. For example, only customers with customer scores greater than 8 on a scale of 10 may be displayed in the list. In other implementations, all customers are included in the ranked list.

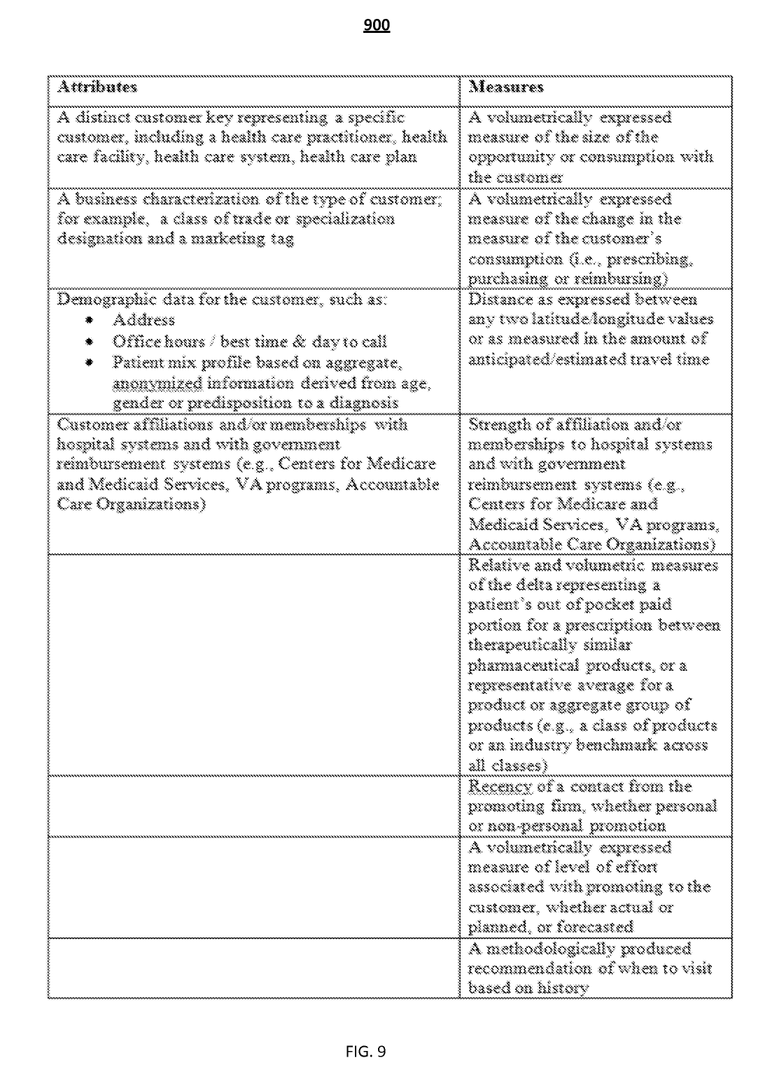

FIG. 9 illustrates a table with the attributes and measures used for calculating customer score. The table illustrates three attributes that may be used for calculating customer score. A customer key may be a distinct key representing a specific customer. A customer may be a physician, health care practitioner, health care facility, health care system or health care plan. The customer key may be a volumetrically expressed measure of the size of the opportunity or consumption associated with the specific customer. The customer may also be characterized based on the type of customer. In some implementations, customers may be characterized based on the trade or specialization designation of the customer. The customer characterization may be a volumetrically expressed measure of the change in the measure of the customer's consumption, for example, prescribing, purchasing or reimbursing. Demographic data for the customer may also be considered in calculating a customer score. For example, address, office hours and patient mix profile. The analytical infrastructure may express the distance between the sales representative user and the customer as the distance between any two latitude/longitude values. In some implementations, the analytical may express the distance between the sales representative user and the customer as estimated or anticipated travel time. The customer affiliations and or memberships with hospital systems and with the government reimbursements systems may also be considered in calculating a customer score. For example, customer affiliations with Centers for Medicare and Medicaid Services, and accountable Care organizations. In some implementations, customer affiliations with Integrated Delivery Networks (IDNs) may also be considered in calculating customer score. The strength of affiliation and or memberships to hospitals systems and with government systems is accessed. The relative and volumetric measures of the delta representing a patient's out of pocket paid portion for a prescription between therapeutically similar pharmaceutical products may be considered when calculating the customer score. Also, the recency of contact from the contacting firm, either by the same sales representative user or a different sales representative user or other entity in the contacting firm, is evaluating in calculating the customer score. A volumetrically expressed measure of level of efforts associated with promoting to the customer and a methodically produced recommendation of when to visit based on history are all evaluated.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network, for example, shared or private computing clouds. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

Pharmaceuticals in various implementations need not necessarily be heavily controlled, and the methods presented herein equally apply to over-the-counter drugs or even potentially to herbal preparations or nutritional supplements that have the potential to have an impact on medical treatment. The use of St. John's Wort to treat a patient with clinical depression may be considered by an implementation, as may a nutritional supplement such as fish oil or a prescription antidepressant.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A computer-implemented method comprising:
identifying an opportunity to contact a customer to promote a pharmaceutical product;
accessing customer dynamics data, wherein the customer dynamics data is descriptive in part of the customer prescribing, purchasing, or reimbursement behavior for the pharmaceutical;
accessing geographical location data;
generating a methodologically-produced customer score based on the customer dynamics data and the geographical location data; and
identifying one or more customers to contact based on the customer score.

2. The computer-implemented method of claim 1 wherein generating a customer score based on the customer dynamics data and the geographical location data comprises generating a customer score based on a weighted average of one or more factors of the customer dynamics data.

3. The computer-implemented method of claim 1 wherein identifying an opportunity to contact a customer comprises identifying an absence of an appointment in a schedule.

4. The computer-implemented method of claim 1 wherein generating a customer score based on the customer dynamics data and the geographical location data comprises generating a customer score by weighing a relative importance of the customer dynamics data and the geographical location data.

5. The computer-implemented method of claim 1 wherein accessing geographical location data comprises accessing the geographical location of one or more customers.

6. The computer-implemented method of claim 1 wherein generating one or more customers to contact based on the customer score comprises generating a ranked list of scored customers.
